(19) United States
(12) Patent Application Publication
(10) Pub. No.: US 2003/0078905 A1
(43) Pub. Date: Apr. 24, 2003

(54) Method of monitoring an enclosed space over a low data rate channel

(76) Inventors: Hans Haugli, Ottawa (CA); Robert Breithaupt, Ottawa (CA)

Correspondence Address: MARKS & CLERK, P.O. BOX 957, STATION B, OTTAWA, ON, K1P 5S7, CA

(21) Appl. No.: 09/983,156

(22) Filed: Oct. 23, 2001

(51) Int. Cl. G06F 7/00

(52) U.S. Cl. 707/1; 707/104.1

(57) ABSTRACT

A system for determining the state of a container or other enclose space from a remote location is described. A monitoring unit in said container includes a video camera that captures an image of the interior portion of the container. A static image of the interior portion of the container when in an empty state is stored in the monitoring unit. An interrogation request to determine the state of the container from is sent from a client over a network to a control station. The interrogation request is transmitted via satellite from the control station to the monitoring unit. Upon receipt of the interrogation request, the monitoring unit compares the current image of the interior portion with the stored image. A response indicative of the state of vacuity of the container is transmitted back to the control station over a low data rate channel for forwarding to the client. The invention also finds application in security applications where only a low data rate channel is available.

### BACKGROUND OF THE INVENTION

1. Field of the Invention

This invention relates to the field of remote monitoring, and in particular to a method of monitoring the state of an enclosed space over a low data rate channel. The invention is applicable, for example, to the monitoring of the state of vacuity of a container, to the determination of whether the doors of a container are open or closed, and the detection of intruders in buildings, vehicles, boats, and the like.

2. Description of Related Art

There are vast numbers of containers in the transportation network at any one time carried on trains, trucks, boats and the like. It is known to track the location and status of these container using remote tracking systems. For example, one system currently in use mounts a data gathering unit in each container. This will receive inputs pertaining to almost any type of parameter that the client might wish to monitor, for example, temperature, humidity, and the like. In addition, such units often have a GPS receiver, either built-in or separate, which permits the unit to transmit data by satellite back the user identifying the current location of the container as well as the various input parameters. The nature of this system means that the bandwidth available for the transmission of data is inherently limited. Typically, low data rate channels are employed with bandwidths in the order of 400 bits per second, possibly extending up to 2 kbits/sec. Such speeds essentially rule out the use of video or imaging techniques in view of the time required to transport the necessary amount of data to create an image even using efficient compression techniques.

There is a need to monitor the state of loading such containers. Often, containers are marked as empty when in fact items remain inside, generally because they have been inadvertently left behind when the container was supposedly emptied. There is also a need to determine whether the doors are open or closed. Currently, this involves adding a special sensor at significant additional cost. Also, security is an ever present problem. The use of a video camera is not a viable option when only a low data rate channel is available.

The state of vacuity is currently determined by providing active ultrasonic sensors which bounce beams of any items in the container. Such sensors, however, have proved to be unreliable. There is a need to provide a system for monitoring the state of vacuity of a container which is reliable and yet which can work with the bandwidth available for satellite-based DGS systems. There is also a need to provide low bandwidth wireless communication systems, for example, a system capable of monitoring an enclosed space that is effective and yet usable over a low data rate channel.

### SUMMARY OF THE INVENTION

According to the present invention there is provided a method of monitoring an enclosed space from a remote location, comprising the steps of providing a monitoring unit in said enclosed space including at least one image sensor capable of creating an image of at least a portion of said space; storing an archive image of said portion in said monitoring unit when said space is in a first known state; subsequently creating a current image of said portion when said space is in an undetermined state; comparing said current image of said portion with said stored image in said monitoring unit to generate an output symbol that depends on the difference between said current image and said stored image; and transmitting said output symbol back to said remote location over a low data rate wireless channel, which is preferably a satellite channel in order to achieve wide area wireless coverage.

In accordance with the principles of the invention, the interior space, for example, of a container is monitored with one or more image sensors, such as a CCD (Charge-Coupled Device), or CMOS image sensor. The image sensor should be capable of forming a digital image of the scene in the field of view of the sensor.

In order to accommodate the low bandwidth requirements, the digital image is not transmitted back to the control station. Instead, a stored image of the container in the empty state is compared with the current video image, and a signal is sent back to the remote monitoring location when the difference exceeds a predetermined tolerance. In the simplest case, the signal could consist of a single bit indicating whether the container is empty or not. In some situations, it is desirable to know whether the container door's are open or closed. By adding an extra bit, the number of possible values can be increased to four, which can represent four different states of the container. In this case, the symbol could indicate whether the container is empty or not, and the doors are open or closed, for example. If more bits are added to the symbol, additional information can be sent. For example, by dividing the image into different sections, and performing the comparison on these different sections, information can be sent as to whether different sections have changed. If the floor is divided into a grid, the degree of emptiness of the container can be determined as one of a number of predetermined percentages, e.g., 10% full, 20% full, etc.

The invention can also be used for intruder detection. A change in the image can be used to indicate the presence of an intruder.

The monitor preferably exists normally in a sleep mode, whereby it is inactive and drawing minimal power, i.e. with the image sensor switched off. It can then be activated to take an image, do the comparison and transmit the result back to the remote location. The trigger can be an interrogation poll signal sent from the remote monitoring location, a local event, such as a door opening, or a prescheduled event. The DGS system typically has a sleep mode, and the monitoring unit can take advantage of the capability build into the DGS terminal unit.

In another aspect the invention provides a system for monitoring an enclosed space from a remote location, comprising a monitoring unit for mounting in said enclosed space and including at least one image sensor capable of creating an image of at least a portion of said space; a memory for storing an archive image of said portion in said monitoring unit when said space is in a first known state; a comparison unit for subsequently comparing a current image of said portion when said space is in an undetermined state with said archive image to generate an output symbol that depends on the difference between said current image and said stored image; and a transmitter for transmitting said output symbol back to said remote location over a low data rate wireless channel, which can conveniently be a satellite channel.

### BRIEF OF THE DRAWINGS

The invention will now be described in more detail, by way of example, only with reference to the accompanying drawings, in which:

FIG. 1 is a schematic view of a container with a monitoring system in accordance with the invention; and

FIG. 2 is a block diagram of the overall monitoring system in accordance with the invention on the network side;

FIG. 3 is a block diagram of the monitoring system at the container; and

FIG. 4 is a flow chart showing the operation of the microprocessor.

### DETAILED DESCRIPTION OF THE INVENTION

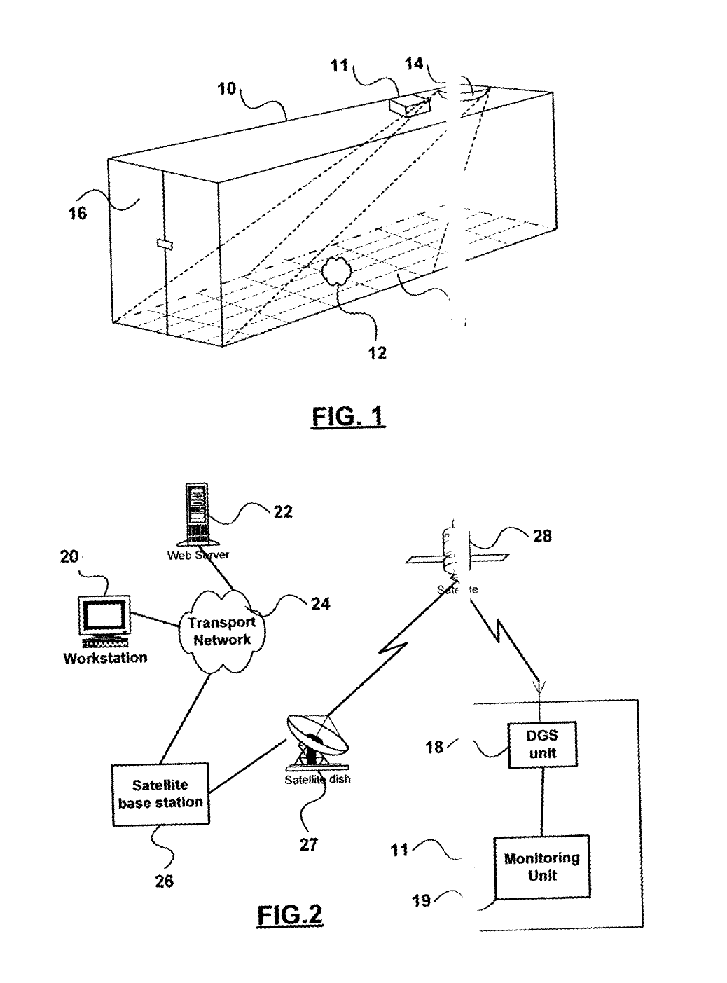

Referring now to FIG. 1, a container 10 can be used for carrying many different types of packages. In the present example, one such package 12 is illustrated. An image sensor or digital camera 14 is mounted at one corner of the container 10. If necessary, additional cameras can be added with overlapping fields of view so that they cover at least the whole of the interior floor space of the container. The cameras are conveniently low-cost CCD or CMOS devices that produce a digital image.

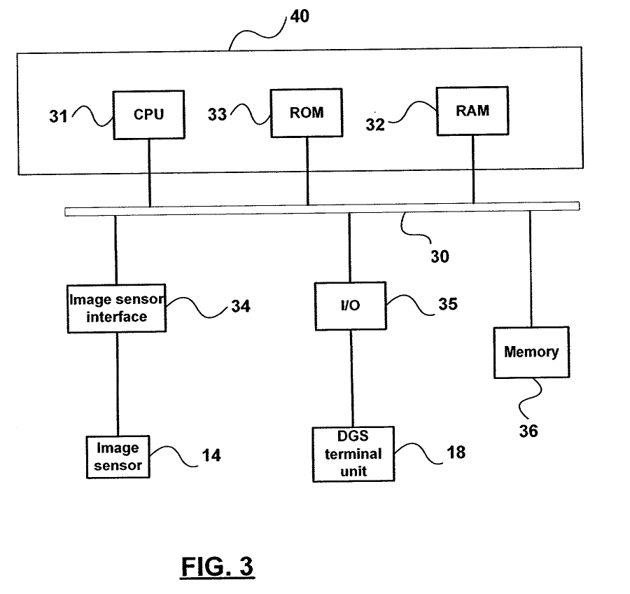

The container contains an electronics package 11, which includes DGS (Data Gathering System) 18, which can conveniently part of a Globalwave™ tracking system, and monitoring terminal unit 19. This will accept a data input and on receipt of an interrogation signal transmit over a low data rate channel back via satellite to a central control station. From there, the data can be sent over a network to a remote client and server. Such as system is shown in FIG. 2.

Client workstation 20 is connected over a public network 24, typically the Internet, to a web server 22, which is also connected, usually via the Internet, to a satellite base station 26. It is possible for the server 22 also to be directly connected to the control station 26. The server 22 interprets commands from the client 20, and in response to a request from the client 20 sends a message to satellite base station 26 for transmission via satellite ground station 27, and satellite 28 to the particular DGS unit 18 identified by the client in the request to the server 22. Each DGS terminal unit 18 has a unique address and this is stored by the satellite base station 26. Details of the basic DGS system are described in U.S. Pat. No. 5,991,279, issued Nov. 23, 1999, the contents of which are herein incorporated by reference.

The monitoring system in the container 10 is shown in more detail in FIG. 3 and contains a microprocessor 40. Bus 30 is connected to a central processing unit 31, random-access-memory 32, and read-only-memory, 33, image sensor interface 34, I/O unit 35, and memory 36.

The image sensor interface 34 is connected to image sensor 14. I/O unit 35 is connected to the DGS terminal unit 18. In practice, the system can also be implemented entirely in software using a digital signal processor.

Upon initialization, an image of the empty container is stored in memory 36. The system then remains inactive and powered down with the image sensor 14 off until a trigger event occurs. This could be an interrogation request received from the client via the DGS terminal unit, or alternatively a prescheduled trigger from a local timer, or a local trigger, for example, activated by the opening of a door 16. The DGS unit 18 uses a special protocol as described in the above-reference US patent to ensure absolute minimum power consumption and thus battery life.

When an interrogation request is received, or another trigger occurs, the DGS terminal unit 18 powers up and so does the monitoring unit 19. The image sensor 14 sends a current image of the monitored space in its field of view to the microprocessor 40. This compares the current image with the corresponding archived image stored in the memory 36. The microprocessor then output a symbol that indicates whether or not a match is present. In this simplest case this just consists of one bit. For example, a 1 might indicate the presence of a match, showing that the container is empty, and a 0 might indicate the presence of a mismatch, showing that the container still contains an unexpected object in the field of view of the camera.

The matching can be carried out to a predetermined degree of tolerance to allow for perturbing factors, such as dirt on the floor. The microprocessor could be programmed to indicate a mismatch when more than a predetermined pixels do not match. Also, the image can be divided into fields, and different fields given different weighting.

The single bit symbol is then sent back to the control station 26 over the low bit rate channel, and this of course occupies minimal bandwidth in the channel.

At the satellite base station the received signal is processed and forwarded to web server 22 for access by the client 20.

In use a client typically accesses a web page on server 22 using http over TCP/IP protocol in the usual manner. The client 20 is given an option to identify the container of interest by its specific code. When the client wishes received data from the identified container, the client sends an http request. The web server 22 in turn sends a message to the satellite base station 26. This identifies a time slot when the DGS unit 18 will be listening and transmits the message via the satellite 28 to the DGS terminal unit 18. This then wakes up the microprocessor 40, which compares the current image from the camera 14 with the corresponding stored image.

The DGS unit terminal 18 forwards the response to web server 22, which then forwards it to the client. The response can be added to other data, such as the position of the identified container, and presented to the client in the form of a table. The table would have a field showing an empty/not empty state of the container.

A useful application of the invention is to determine the state of closure of the container doors. If the field of view of the camera or cameras includes portions of the doors 16 of the container, the image will of course change depending on the state of closure of the doors. In a preferred embodiment, the image field is divided into sub-fields of which one covers only portions of the doors of the container, and which is not normally blocked by the presence of objects on the container floor. When the doors are open, this part of the image will change, and this change can be used to indicate the state of closure of the doors. In this case, an extra bit is added to the transmitted symbol to include door state. This is an important practical application of the invention because adding a door sensor with the necessary additional wiring can be expensive.

In a further refinement, the floor of the container is divided into a notional grid 13. The will be perceived by the camera as an array of non-parallel intersecting lines due to perspective effects. A comparison is carried out for each sub field in the image. For example, if the camera covers the whole of the floor of the container, and 50% of the grid squares result in a match, the system can conclude that the floor space of the container is 50% occupied. The monitoring unit can be pre-programmed for different predetermined levels of occupancy, and depending on the number of levels chosen, the symbol transmitted back to the control station 26 can be allotted an appropriate number of bits. For example, a three-bit symbol would allow information to be transmitted as to the state of the doors (open or closed) and six different levels of occupancy, for example, empty, 20%, 40%, 60%, 80%, full.

It is of course not necessary to physically mark a grid on the floor of the container. The microprocessor 40 can be programmed to process portions of the image field corresponding to such a notional grid taking into account the perspective effects.

A load element in the trailer may occupy a significant height and limited floor area. If such a load element is located near the end away from the doors, it may partially block the sensor 14 view of the floor and beyond the load. This ambiguity may be dealt with by employing two sensors 14 spread apart and comparing images.

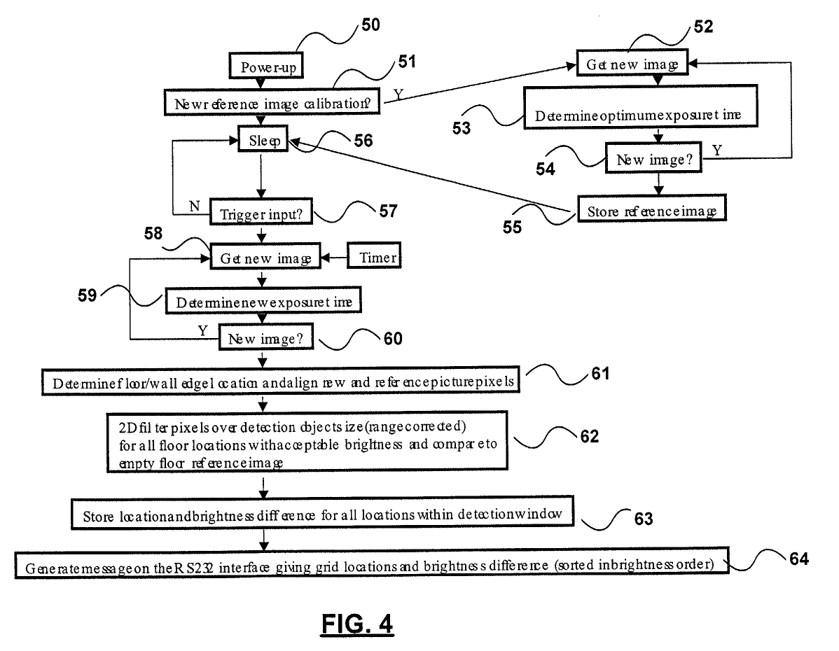

FIG. 4 is a detailed flow chart showing the operation of the microprocessor 40. On power-up at step 50, a determination is made as to whether a new image calibration is required. If yes, which would normally occur on initialisation of the system, the microprocessor gets a new image from the image sensor at step 52, determines the exposure time, step 53, obtains a new image, step 54. If the exposure is correct, this image is stored at step 55, otherwise a new image is taken.

The system then goes into a sleep mode at step 56. In this state, the image sensor is off and only minimal power is required to keep the system active. When a trigger occurs at step 57, the image sensor is powered up and a new image is taken. A trigger may arise from a scheduler, such as a timer, a request from the base station, or a local event, such as the opening of a door. The system then gets a new image, step 58, determines a new exposure time, step 59, and when iterates until the exposure time is correct.

At step 61, the system then determines the floor/wall edge location and aligns the new pixels with the pixels in the reference image. At step 62, these are then filtered and compared for a predetermined object size. The range is corrected to take into account perspective effects.

At step 53, the location and brightness difference is stored for all locations within the detection window. Finally, at step 64 a message is generated on the RS232 serial interface to the microprocessor giving grid locations and brightness difference. This information is then transmitted back to the base station as a message containing only a few bits corresponding to predetermined states.

The image sensor 14 may be surrounded by infrared LEDs (Light Emitting Diodes) to illuminate the interior of the container in the dark.

The invention has been described with one imaging device although it will be understood that any number can be employed. In many cases, one camera with a wide field of view will be sufficient.

It will be appreciated that the invention permits full advantage to be taken of image sensing technology, but because in accordance with the invention only minimal information is transmitted, a few bits at the most, the invention can be applied in situations where only a low data rate channel is available and which therefore would normally preclude the use of video imaging technology.

The invention also finds application in security applications. The monitoring unit can send back a single bit indicating that a certain predetermined portion of the image field has changed, indicating that an intruder of more than a known size is present in a monitored space.

Although one implementation of the invention has been described in detail, it is clearly understood that the same is by way of illustration and example only and is not to be taken by way of limitation, the spirit and scope of the invention being limited only to the terms of the appended claims.

1. A method of monitoring an enclosed space from a remote location, comprising the steps of:
providing a monitoring unit in said enclosed space including at least one image sensor capable of creating an image of at least a portion of said space;
storing an archive image of said portion in said monitoring unit when said space is in a first known state;
subsequently creating a current image of said portion when said space is in an undetermined state;
comparing said current image of said portion with said stored image in said monitoring unit to generate an output symbol that depends on the difference between said current image and said stored image; and
transmitting said output symbol back to said remote location over a low data rate wireless channel.

2. A method as claimed in claim 1, wherein said output symbol indicates whether said current image matches said stored image to a predetermined degree of tolerance.

3. A method as claimed in claim 2, wherein said output symbol is a single bit.

4. A method as claimed in claim 3, wherein said single bit indicates whether said container is nominally empty.

5. A method as claimed in claim 3, wherein said output symbol has a predetermined number greater than one of values that each correspond to particular state of the interior space.

6. A method as claimed in claim 5, wherein said values correspond to predetermined loading states of said enclose space.

7. A method as claimed in claim 5, wherein said enclosed space is a container with doors, said image sensor is mounted to view at least a portion of said doors, said current image is compared with said archive image to determine whether said doors are in an open or closed state, and said symbol represents includes a value representing the open or closed state of said doors.

8. A method as claimed in claim 1, further comprising sending an interrogation request from a client over a network to a control station;
transmitting said interrogation request via satellite from said control station to said monitoring unit;
in response to receipt of said interrogation request comparing said current image to said archive image; and
sending said output symbol back to said client.

9. A method as claimed claim 1, wherein said current image is compared with said stored image in accordance with a predetermined schedule.

10. A method as claimed in claim 1, wherein said current image is compared with said stored image in response to a local event.

11. A method as claim 1, wherein said monitoring unit is normally in an inactive sleep mode except when creating a current image in response to an internal or external trigger.

12. A method as claimed in claim 1, wherein said wireless channel is a satellite channel.

13. A system for monitoring an enclosed space from a remote location, comprising:
a monitoring unit for mounting in said enclosed space and including at least one image sensor capable of creating an image of at least a portion of said space;
a memory for storing an archive image of said portion in said monitoring unit when said space is in a first known state;
a comparison unit for subsequently comparing a current image of said portion when said space is in an undetermined state with said archive image to generate an output symbol that depends on the difference between said current image and said stored image; and
a transmitter for transmitting said output symbol back to said remote location over a low data rate wireless channel.

14. A system as claimed in claim 13, wherein said output symbol indicates whether said current image matches said stored image to a predetermined degree of tolerance.

15. A system as claimed in claim 13, wherein said output symbol is a single bit.

16. A system as claimed in claim 15, wherein said single bit indicates whether said container is nominally empty.

17. A system as claimed in claim 15, wherein said output symbol has a predetermined number greater than one of values that each correspond to particular state of the interior space.

18. A system as claimed in claim 17, wherein said values correspond to predetermined loading states of said enclose space.

19. A system as claimed in claim 17, wherein said enclosed space is a container with doors, said image sensor is mounted to view at least a portion of said doors, said current image is compared with said archive image to determine whether said doors are in an open or closed state, and said symbol represents includes a value representing the open or closed state of said doors.

20. A system as claimed in claim 13, further comprising:
a client connected to a base station over a network;
a transmitter for transmitting said interrogation request via satellite from said base station to said monitoring unit; and
said monitoring unit comparing said current image to said archive image in response to receipt of said interrogation request and sending said output symbol back to said client.

21. A system as claimed claim 13, further comprising a timer in said monitoring unit for comparing said current image with said stored image in accordance with a predetermined schedule.

22. A system as claimed in claim 13, further comprising a local event trigger for causing said monitoring unit to compare said current image with said stored image in response to a local event.

23. A system as claim 13, further comprising a sleep unit for putting said monitoring unit normally into an inactive sleep mode except when creating a current image in response to an internal or external trigger.

24. A system as claimed in claim 13, wherein said wireless channel is a satellite channel.

25. A system as claimed in claim 13, further comprising a light source for illuminating the field of view of said at least one image sensor during the taking of an image.

26. A system as claimed in claim 25, wherein said light source comprises an array of infrared LEDs.
